(19) United States
(12) Patent Application Publication
(10) Pub. No.: US 2017/0209723 A1
(43) Pub. Date: Jul. 27, 2017

(54) Charging station fire suppression receptacle

(71) Applicant: GelTech Solutions, Inc., Jupiter, FL (US)

(72) Inventor: Peter Cordani, Palm Beach Gardens, FL (US)

(21) Appl. No.: 15/483,380

(22) Filed: Apr. 10, 2017

Related U.S. Application Data
(63) Continuation-in-part of application No. 14/682,542, filed on Apr. 9, 2015.
Application No. 14/682,542 is a continuation-in-part of application No. 14/620,925, filed on Feb. 12, 2015.
(60) Provisional application No. 62/064,011, filed on Oct. 15, 2014.

(51) Int. Cl. A62C 3/16; B65D 65/38; A62D 1/00; H02J 7/00; H01M 10/0525; H01M 2/10; H01M 10/653; A62C 35/10; A62D 1/02

(52) U.S. Cl. CPC A62C 3/16; A62C 35/10; B65D 65/38; A62D 1/0064; A62D 1/0071; A62D 1/0028; H01M 10/0525; H01M 2/1094; H01M 10/653; H02J 7/0027; A62C 99/0045

(57) ABSTRACT

A receptacle for use with lithium ion charging stations. The receptacle contains an admixture for use in suppressing a cellular telephone battery fire. The admixture is a hydrated super absorbent polymer having substantially superior fire suppression properties. When used with lithium ion batteries, once a battery is arcing or an excess buildup of heat occurs, the walls of the receptacle will rupture and the admixture will cover the specific area causing a thermal event. These particular properties and ratios of the admixture will enable a fire to be extinguished. The receptacle may include heat or pressure sensors.

### PRIORITY CLAIM

In accordance with 37 C.F.R. 1.76, a claim of priority is included in an Application Data Sheet filed concurrently herewith. Accordingly, the present invention is a Continuation-In-Part application that claims priority to U.S. application No. 14/682,542 entitled “FIRE SUPPRESSION PACKAGING”, filed Apr. 9, 2015, which is a Continuation-In-Part application that claims priority to U.S. Application Number 14/620,925, entitled “FIRE SUPPRESSION PACKAGING AND METHOD OF MANUFACTURE”, filed Feb. 12, 2015, which claims priority to U.S. Provisional Patent Application No. 62/064,011, entitled “BATTERY STORAGE DEVICE AND METHOD OF MANUFACTURE”, filed Oct. 15, 2014. The contents of the above referenced applications are incorporated herein by reference.

### FIELD OF THE INVENTION

This invention relates to the field of fire suppression, and more particularly, to a safety box for use with cellular telephone charging stations and the like smart devices, by providing a safety box employing hydrated amounts of super absorbent polymer constructed and arranged to arrest and extinguish a lithium ion battery fire.

### BACKGROUND OF THE INVENTION

The occurrence of cellular telephone fires is well known. Samsung's Galaxy Note 7 is likely the most well known cellular telephone for battery failures that lead to fires. However, Samsung is not alone with lithium ion battery fires being a problem. Unfortunately, all lithium ion based telephones and smart devices are at risk should there be a flaw in manufacturing or if the lithium ion battery is not properly recharged. Poor manufacturing can result in latent electrical short circuits, and overcharging can result in oxygen bubbles forming in the lithium gel, which is reactive with metallic lithium. Thermal runaway is also common, the result of a feedback loop in which a lithium ion battery can quickly overheat and explode.

Cellular telephones have become so prevalent in society that public telephones, were were commonly provided in transient locations less than 10 years ago, are now non-existent. For instance, most airports lack access to public telephones, yet now provide Wi-Fi that a smart phone can access. Unique to smart phone devices is the ability of the owner to perform most any function on the device, as if the individual has a full computer system at their disposal. Further, the smart devices can also function as cameras, flashlights and alarm clocks, all of which draw upon the rechargeable lithium ion battery. The length of time a cellular telephone, or the like smart device, lasts between recharging is based upon the use, as well as the condition of the battery. For this reason, the use of recharging stations has become very popular and in many areas replaces public access telephones. A recharging station may simply consist of a plurality of AC outlets, or it may be as sophisticated as a station having various USB cable connections and hard line internet connections. In either event, a recharging station will find a collection of cellular telephones, smart devices, and portable computers in need of recharge. Since the step of recharging the lithium ion battery is when a latent defect will breach, the charging stations are now the most susceptible areas for a lithium ion battery fire to occur.

### SUMMARY OF THE INVENTION

Disclosed is a receptacle housing an admixture capable of suppressing or extinguishing a lithium ion battery fire in a cellular telephone or the like smart device. The receptacle can be sized to fit cellular telephones, tablets, laptops and the like. The receptacle includes a hydrated super absorbent polymer having an easily accessible cavity. The receptacle is available to receive the battery powered device should an arcing occur, wherein packaging within the receptacle will release the admixture to suppress the battery thermal event. The receptacle contains an admixture of hydrated super absorbent polymer capable of fire suppression and extinguishing of fires. The admixture is used to cool the immediate area around the battery and, should an arcing occur, the admixture can flood the device for purposes of fire suppression. The admixture has a viscosity that inhibits flowing to adjacent areas and is non-conductive. The properties of the admixture inhibit a restart of a battery fire and can encapsulate noxious and toxic gases produced by the fire.

Accordingly, it is an objective of the present invention to provide a container, for placement at recharging stations, having an admixture of non-conductive hydrated super absorbent polymer for suppression of lithium ion battery fires associated with cellular telephones and the like smart devices.

It is also an objective of the present invention to provide a receptacle to provide a cooling effect for a lithium powered device which poses a risk for overheating.

Still another objective of the present invention is to provide a receptacle for battery powered devices that will not short out the device if the admixture directly contacts the device. Should a device fail, by quick suppression and use of a non-conductive material, the memory of the device can be saved.

It is still yet another objective of the present invention to provide a receptacle to work with a unique admixture of super absorbent polymer and water which has viscosity that enables the admixture to adhere to horizontal, vertical, inclined, and curved surfaces.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial view of a charging station; and

FIG. 2 is a perspective view of a receptacle for use in combination with a charging station.

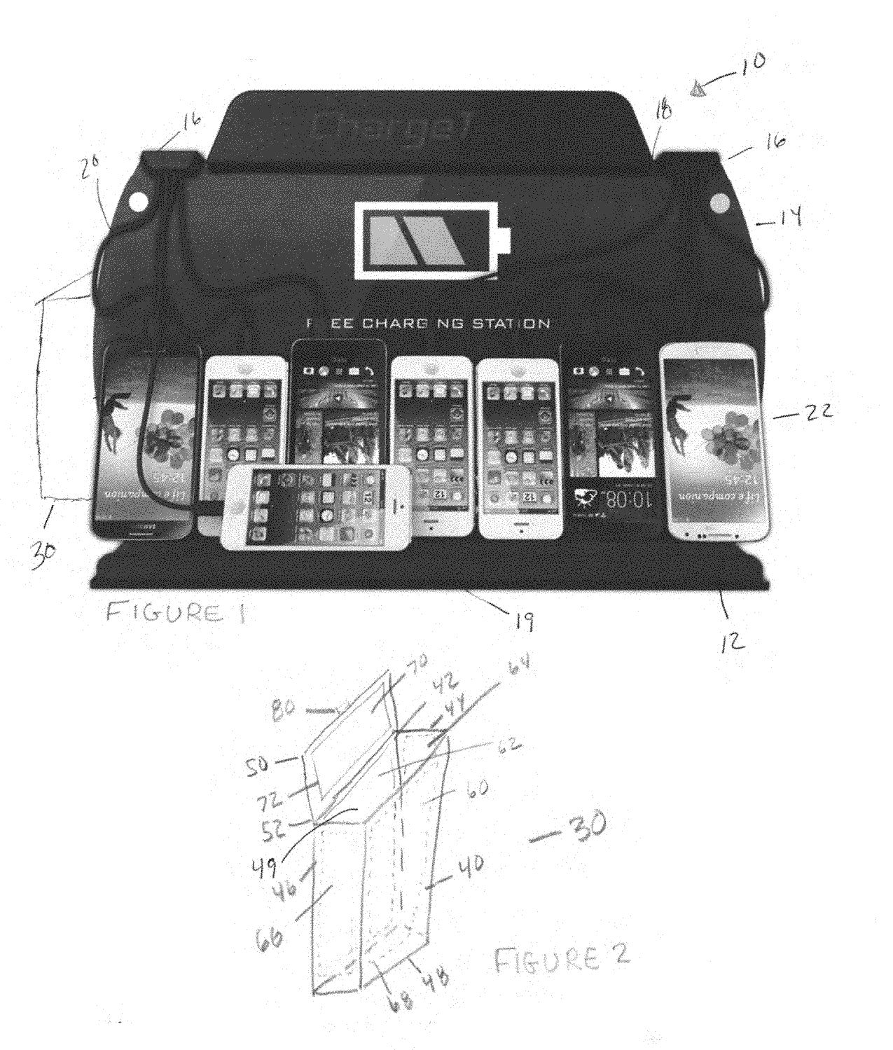

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Battery fires present different and unique problems pertaining to how these fires should be extinguished and suppressed. While water is commonly employed to extinguish fires because it can quickly cool down the burning material, water does not necessarily work on a battery fire, especially since water may short circuit a battery and/or operating device. Using water on a lithium battery fire can aggravate the situation. In the preferred embodiment of the present invention, an admixture of a super absorbent polymer and water is placed adjacent the phone battery. By stopping a thermal build up before combustion, or at the point in time that battery arcing occurs, the ability to suppress or extinguish the thermal event is greatly increased.

According to the present invention, an admixture of a super absorbent polymer and water is placed in packets secured to the inner wall of the receptacle. The receptacle is placed near a battery charging station should a battery or a component that contains a battery cause a thermal event. Should a battery thermal overheat event occur, the overheating device is placed into the receptacle, wherein the admixture operates to displace heat and should the thermal event accelerate, suppress a battery fire. The aqueous admixture of the super absorbent polymer enables the admixture to be confined to a particular area because of its relatively high viscosity. The properties of the admixture, in particular its viscosity, enable the admixture to remain on vertical, horizontal, and curved surfaces formed by the receptacle. Unlike pure water, the admixture does not provide an electrically conductive path. The admixture has properties that enable the dissipation of heat, suppress the spread of a battery fire, and extinguish any fire that has attached itself to the device affected. A ratio of about 4 grams of said super absorbent polymer is hydrated with about 0.1 gallons of water to suppress a lithium ion battery fire. It is to be understood that the ratio of super absorbent polymer to water can vary to produce various physical states of the super absorbent polymer. For example, the viscosity can be adjusted to form a gel, slurry, liquid, semi-liquid, or foam. In a preferred embodiment, the ratio of super absorbent polymer to water is adjusted to produce a gel. The gel itself can also vary in degrees of viscosity.

In a preferred embodiment, a super absorbent aqueous based polymer is added to water in a dry weight from about 0.1 gram to about 100 kilograms, wherein the volume of water ranges from about 0.1 liters to about 100 liters of water. In one preferred embodiment, a super absorbent aqueous based polymer is added to water in an amount effective to extinguish and suppress fire. The admixture of Applicant's potassium based super absorbent polymer, marketed under the trademark FIREICE®, has physical and chemical properties which enable the admixture to entrap and retain the noxious and/or toxic gasses.

Referring now to the Figures, set forth is a pictorial of a conventional charging station 10 having a support base 12 and a power supply base 14. The power supply base 14 has a plurality of charging cables 16 that may be of a single style, such as an Apple iOS 18 or an Android OTG 20, or any combination thereof. In this example, the charging station provides both types of cables. The support base 12 is depicted with a variety of Apple and Samsung telephones 22. The receptacle 30 of the instant invention is attached to the power supply base 14 for receipt of a telephone overheating during the charging event. If the owner of the telephone knows that his/her telephone had been dropped or otherwise damaged, the owner may place the telephone within the receptacle 30 during the recharging stage as a precautionary event. Alternatively, should the telephone begin to heat up while charging, the telephone can be immediately placed within the receptacle 30. The support base 12 and/or power supply base 14 may include a temperature sensor 19 that can detect a battery that is overheating. The temperature sensor 19 would provide an audible alarm or visual light that a thermal event is occurring. Power to the telephone can be disconnected automatically upon the initiation of the thermal event, and the owner of the telephone can deposit the telephone within the receptacle 30.

The receptacle 30 is defined by a front wall 40, a rear wall 42, opposing side walls 44 and 46, and a bottom wall 48. A lid 50 is pivotally hinged 52 to the rear wall 42, forming an interior cavity 49 that is lined with a thin wall of plastic forming packets. The packets may include a non-woven polypropylene material therein. The packets contain an admixture, which has the consistency of a gel wherein the use of non-woven polypropylene material helps prevent settling when the packets are placed in a vertical position, such as along the sidewalls. Alternatively, the packets may include baffles, ribs or include individual receptacles, similar to a bubble pack, to inhibit settling of the admixture.

While polypropylene is considered the preferred embodiment, the thin wall used for encapsulating the fire suppressant admixture can be also be made of: polyethylene, polyurethane, polyisoprene, elastomers, rubber-like resilient materials, silicone rubber, nitrile rubber, butyl rubber or combinations thereof. The function of the thin wall is to melt should there be a thermal event raising sufficient heat so as to cause a breach of the packet.

In the preferred embodiment of the present invention, an admixture of a super absorbent polymer and water is placed in the receptacle that receives a battery or a component that contains a battery; the aqueous admixture of the super absorbent polymer and water having properties which enable the super absorbent polymer and water admixture to be confined to a particular area because of its relatively high viscosity. The properties of the admixture, in particular its viscosity, enable the admixture to remain on vertical, horizontal, and curved surfaces formed by the receptacle. Unlike pure water, the admixture does not provide an electrically conductive path. The present invention adds a predetermined amount of the super absorbent polymer to a predetermined amount of water to obtain an admixture which has properties that enable the admixture to suppress the spread of a battery fire and extinguish any fire that has attached itself to the individual. A ratio of about 4 grams of said super absorbent polymer is hydrated with about 0.1 gallons of water to suppress a lithium ion battery fire within the cavity. The thin wall of plastic encapsulates a non-woven polypropylene material therebetween, which is saturated with the hydrated admixture; the non-woven polypropylene preventing gravity settling. Alternatively, the admixture may be placed in smaller modules, such as bubble packs, which would eliminate settling of the admixture over long periods of time.

The admixture of Applicant's potassium based super absorbent polymer, marketed under the trademark FireIce®, and water has physical and chemical properties which enable the admixture to entrap and retain the noxious and/or toxic gasses and prevent the release of these gases into the atmosphere.

The packets holding the admixture are depicted in FIG. 2 with a front packet 60 secured to the inner surface of the front wall 40, a rear packet 62 secured to the rear wall 42, opposing side wall packets 64 and 66 attached to the side walls 44 and 46, a bottom packet 68 attached to the bottom wall 48, and an inner packet 70 attached to the lid 50; all the packets containing the admixture. One or more of the packets can be pressurized, and the pressure monitored by a pressure detection sensor 72. The detection of a pressure change would indicate a possible breach in the wall of a packet. A breach would occur if the packet was melted during a thermal event and the admixture released. Should a release occur, the pressure sensor 72 may be used to operate a latch mechanism 80 to prevent the opening of the receptacle 30. For instance, should a battery have a thermal event while within the receptacle, the admixture would be released from the packet and the thermal event suppressed. However, the packet will have expelled pressure, thereby operating the sensor and causing the latch 80 to operate and seal the battery within the receptacle 30. As another example, if a packet is breached due to a sharp object or other abuse, the latch would operate and seal the receptacle, preventing any reliance upon the receptacle for control of a thermal event.

In an alternative embodiment, a temperature sensor may be used in place of a pressure sensor. A temperature sensor would detect only a thermal event, and not a breach of a packet. Further, an audible or visual alarm can be used to indicate a thermal event, a breach of the packet, or the latching of the receptacle.

The use of a packet is selected for its ability to be flexible and leak resistant with an ability to hold the hydrated material over a long period of time without evaporation. The preferred admixture is a biodegradable, super absorbent, aqueous-based, cross-linked, modified polyacrylamides/potassium acrylate polymer. Other polymers may be used, but not with the same quality level; examples of these polymers are cross-linked modified polyacrylamides/sodium acrylate, carboxy-methylcellulose, alginic acid, cross-linked starches, and cross-linked polyaminoacids.

While not a preferred embodiment, the fire suppressant composition can be any conventional fire suppressant, including biodegradable, super absorbent, aqueous-based polymers. Examples of these polymers are cross-linked modified polyacrylamides/potassium acrylate or polyacrylamides/sodium acrylate. Other suitable polymers include, albeit are not limited to, carboxy-methylcellulose, alginic acid, cross-linked starches, and cross-linked polyaminoacids. Examples of known fire suppressants include, without limitation, those marketed under the brand name of: FIREICE marketed by GelTech, Barricade II marketed by Barricade International, Thermo Gel 500p marketed by Thermo Industries, AFG Firewall marketed by NoChar, Phos-Chek, AquaGel-K, Focstop-K or Insul-8 marketed by ICL Performance Products, Blaze Tamer 380 marketed by Bio Central Labs, and Tetra KO marketed by Earth Clean Corporation. Other known materials that can be made effective include: Purple K potassium bicarbonate, mono ammonium phosphate, sodium bicarbonate, potassium bicarbonate & Urea Complex (AKA Monnex), potassium chloride (Super-K), MET-L-KYL/PYROKYL variation of sodium bicarbonate, a blended sodium chloride, or a copper extinguishing agent such as that developed by the U.S.. Navy for fighting lithium and lithium alloy fires.

As used herein, a “fire suppressant” and “fire extinguishing” composition is used interchangeably, and is meant to be inclusive of all components of the composition. In some embodiments, the fire extinguishing composition comprises one or more fire suppressant compounds. In other embodiments, the fire extinguishing composition comprises one or more common components of fire suppressant formulations, such as: fire suppressant salts, known or conventional fire suppressants, corrosion inhibitors, spoilage inhibitors, foaming agents, non-foaming agents, flow conditioners, stability additives, thickening agents, pigments, dyes or the like.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fire suppression receptacle for use with lithium ion battery charging stations comprising:
a housing having a front wall, a back wall, opposing side walls, a bottom wall, and a lid pivotally attached to the back wall forming a receptacle when the lid is placed in a closed position;
a fire suppressant packet secured to each said wall forming the receptacle, said fire suppressant packet formed from a sheet of material having a first side wall defined by first and second end edges and first and second longitudinal side edges, and a second side wall having a mirror image of said first side wall and secured to said first side wall, forming a space therebetween;
an admixture of hydrated super absorbent polymer capable of treating a lithium ion battery fire contained in said space of each said packet;
wherein if a lithium ion battery placed within the receptacle has a thermal event, the excessive heat will melt a portion of said packet and release said admixture for dissipating excess heat and suppressing a battery fire.

2. The fire suppression receptacle according to claim 1 wherein said flexible sheet of material is polypropylene.

3. The fire suppression receptacle according to claim 1 wherein said flexible sheet of material is selected from the group consisting of: low density polypropylene, polypropylene, polyesters, polyethylene, polyurethane, polyisoprene, elastomers, rubber-like resilient materials, silicone rubber, nitrile rubber, butyl rubber or combinations thereof.

4. The fire suppression receptacle according to claim 1 wherein said admixture is potassium based.

5. The fire suppression receptacle according to claim 1 wherein said admixture is an admixture of a combination of polyacrylamides and potassium acrylate.

6. The fire suppression receptacle according to claim 4 wherein said admixture is marketed under the brand FireIce®.

7. The fire suppression receptacle according to claim 1 wherein said admixture has a ratio of about 1 gram of said super absorbent polymer hydrated with about 0.4 liters of water.

8. The fire suppression receptacle according to claim 1 including a pressurized admixture packet that will assist in the flow of admixture toward a breach in the packet.

9. The fire suppression receptacle according to claim 8 including a pressure sensor constructed and arranged to detect a breach in said pressurized admixture packet.

10. The fire suppression receptacle according to claim 9 including an alarm notification in the event of a breach in said pressurized admixture packet.

11. The fire suppression receptacle according to claim 1 including a non-woven polypropylene placed within said packet wherein said admixture does not settle when attached thereto.
